(19) United States
(12) Patent Application Publication
(10) Pub. No.: US 2008/0311341 A1
(43) Pub. Date: Dec. 18, 2008

(54) Article Having Impact Resistant Surface

(76) Inventors: Chul S. Lee, Northville, MI (US); Ankur M. Bhosale, Canton, MI (US); Randy Fleck, Nazareth, PA (US)

Correspondence Address: HOWARD & HOWARD ATTORNEYS, P.C.;BASF SE, THE PINEHURST OFFICE CENTER, SUITE #101, 39400 WOODWARD AVENUE, BLOOMFIELD HILLS, MI, 48304-5151, US

(21) Appl. No.: 12/133,713

(22) Filed: Jun. 5, 2008

Related U.S. Application Data
(60) Provisional application No. 60/942,521, filed on Jun. 7, 2007.

(51) Int. Cl. B32B 1/04

(52) U.S. Cl. 428/119

(57) ABSTRACT

An article manufactured from a polymer filled with fibers includes a plurality of ribs orientated and configured in a unique manner to improve resistance to an impact from an object. The ribs extend from a planar portion of the article. A fillet interconnects the ribs and the planar portion and includes a fillet radius of at least 0.75 mm. The fibers of the polymer are aligned within the article parallel to a flow of the polymer when injected into a mold during a molding process. The ribs are oriented in a pattern relative to the aligned fibers to maximize the impact resistance of the article.

### CROSS REFERENCE TO RELATED APPLICATION

This application claims the benefit of U.S. Provisional Patent Application Ser. No. 60/942,521 filed on Jun. 7, 2007, the disclosure of which is hereby incorporated by reference.

### BACKGROUND OF THE INVENTION

1. Field of the Invention

The subject invention generally relates to an article having an impact resistant surface for preventing damage to the article upon impact by an object.

2. Description of the Related Art

With the increased cost of metals, such as aluminum and steel, various articles previously manufactured from metals are now being manufactured from a polymer. The polymer is typically filled with glass fibers to increase the strength of the polymer. The articles are not only cheaper to produce from the polymer, but also weigh much less. However, these various polymer articles must meet predetermined design requirements. These design requirements include impact resistance, i.e., the polymer articles must still be capable of withstanding an impact from an object without fracturing. Furthermore, it is common that the amount of these fibers relative to the amount of the polymer and/or the size (e.g. length, diameter, etc.) of these fibers is not ideal for optimum impact resistance of the articles. In order to meet the required impact resistance, longitudinally extending ribs are typically incorporated into a planar portion of the polymer article. The ribs are disposed on an outer surface of the polymer article and exposed to an impact from an object. These longitudinally extending ribs are integrally formed with the polymer article, and extend in parallel rows along a length of the polymer article. The longitudinal ribs increase the geometric strength (rigidity) of the polymer article, i.e., the longitudinal ribs increase resistance to bending or flexing.

The glass fibers typically align themselves with the direction of flow of the polymer as the polymer article is being formed, i.e., the glass fibers align with the direction of flow of the polymer being injected into a mold. A strength of the glass filled polymer is greatest when a loading is applied in the direction of the orientation of the glass fibers, i.e., parallel to the orientation of the glass fibers, and is least when the loading is applied in a direction perpendicular to the orientation of the glass fibers. A resistance to elongation of the glass filled polymer article is least when the loading is applied in the direction of the orientation of the glass fibers, i.e., parallel to the orientation of the glass fibers, and is greatest when the loading is applied in a direction perpendicular to the orientation of the glass fibers. Therefore, the resistance to elongation acts opposite the strength, with the resistance to elongation of the glass filled article being highest when the loading is applied perpendicular to the orientation of the glass fibers in the polymer article and the strength of the glass filled article being highest when the loading is applied parallel to the orientation of the glass fibers in the polymer article.

The overall impact resistance of the polymer article is dependent upon both the strength and the resistance to elongation of the polymer article. Therefore, a longitudinal rib pattern in which the ribs are aligned parallel with the orientation of the glass fibers in the polymer article maximizes the bending strength, but minimizes the resistance to elongation, whereas a longitudinal rib pattern in which the ribs are aligned perpendicular with the orientation of the glass fibers in the polymer article minimizes the bending strength and maximizes the resistance to elongation.

An example of an article previously manufactured from steel that is now manufactured from the polymer is an oil pan (fluid reservoir) for an internal combustion engine. The longitudinal ribs run substantially along the entire length of the oil pan, such that the longitudinal ribs extend along a longitudinal axis of a vehicle and parallel with a direction of travel of the vehicle. As such, any flying object, for example a stone or some other debris, will most likely be traveling in a direction parallel the longitudinal ribs. Referring to Prior Art FIG. 1, a cross section of a prior art rib is shown. As known in the prior art, each of the longitudinal ribs include a pair of side surfaces in spaced parallel relationship defining a generally rectangular cross section. Each of the longitudinal ribs extends upward from a planar portion of the oil pan, with the side walls intersecting the planar portion at an inner corner, i.e., a vertex having an approximate angle of 90°. In other words, the ribs are substantially perpendicular to the planar portion of the oil pan. Upon impact by the object, the substantially perpendicular intersection between the side surfaces of the ribs and the planar portion of the oil pan creates a concentrated stress point in the planar portion of the polymer oil pan at the vertex of the inner corner. While the longitudinal ribs increase the impact resistance of the polymer oil pan, the polymer oil pan remains susceptible to fracture at these concentrated stress points located at the intersections of the side surfaces of the longitudinal ribs and the planar portion of the oil pan. Accordingly, there remains a need to further increase the impact resistance of these various polymer articles.

### SUMMARY OF THE INVENTION AND ADVANTAGES

The subject invention provides an impact resistant article. The article comprises a planar portion. A plurality of ribs extends outwardly from the planar portion. The plurality of ribs includes a pair of side surfaces in spaced parallel relationship. The pair of side surfaces is perpendicular to the planar portion. Each of the plurality of ribs further includes a top surface extending between the pair of side surfaces. The pair of side surfaces is spaced from each other a width between the range of 2.00 mm and 3.00 mm. The top surface is parallel to and spaced from the planar portion a height between the range of 2.00 mm and 6.00 mm. A fillet interconnects the planar portion and each of the pair of side surfaces. The fillet includes a fillet radius between the range of 0.75 mm and 2.00 mm.

The planar portion, the plurality of ribs and the fillet are all integrally formed from a polymer. The polymer includes fibers between the range of 30% and 40% by weight. The fibers are substantially oriented in a primary direction, with the plurality of ribs including a geometric orientation relative to the primary direction.

Accordingly, the subject invention improves the impact resistance of the polymer article by placing a fillet at the intersection of the side surfaces of the ribs and the planar portion, thereby eliminating the approximate ninety degree intersection previously utilized between the side surfaces of the ribs and the planar portion. The fillet more efficiently spreads an impact force applied to the ribs to the planar portion, thereby minimizing the concentrated stress point previously located at the inner corners of the intersection between the side surfaces of the ribs and the planar portion of the article. The geometric orientation of the ribs relative to the fibers further increases the impact resistance of the article by maximizing the strength of the material provided by the fibers.

### BRIEF DESCRIPTION OF THE DRAWINGS

Other advantages of the present invention will be readily appreciated, as the same becomes better understood by reference to the following detailed description when considered in connection with the accompanying drawings wherein:

Prior Art FIG. 1 is a cross section of one of the ribs utilized in the prior art;

FIG. 2 is a perspective view of an underside of a polymer reservoir incorporating a plurality of ribs according to the subject invention;

FIG. 3 is a cross section of one of the ribs of the subject invention;

FIG. 4A is a top view of a first alternative rib configuration shown on a cover;

FIG. 4B is a top view of a second alternative rib configuration shown on a cover;

FIG. 4C is a top view of a third alternative rib configuration shown on a cover;

FIG. 4D is a top view of a fourth alternative rib configuration shown on a cover;

FIG. 4E is a top view of a fifth alternative rib configuration shown on a cover; and

FIG. 5 is an enlarged top view of the third alternative rib configuration and the fourth alternative rib configuration shown in FIGS. 4D and 4E respectively.

### DETAILED DESCRIPTION OF THE INVENTION

Referring to the Figures, wherein like numerals indicate corresponding parts throughout the several views, an article is shown generally at 20. Preferably, the article 20 is manufactured from a polymer, i.e., a plastic material. In the context of the present invention, it should be understood that the polymer can be neat, i.e., virgin, uncompounded resin, or that the polymer can be an engineered product where the resin is compounded with other components, for example with select additives to improve certain physical properties. Such select additives include, but are not limited to, lubricants, non-fiber impact modifiers, fiber-based impact resistance additives, coupling agents, and colorants, such as pigments and the like. Preferably, the polymer is a nylon, such as nylon 6 or nylon 6/6. The polymer can include nylon 6 only, nylon 6/6 only, or various blends of the two. However, it should be understood that polymers other than nylon may also be used to manufacture the article 20.

Although not required, the polymer is typically filled with fibers 22 in an amount of from thirty percent (30%) to forty (40%) by weight based on a combined total weight of the polymer and the fibers 22. More preferably, the fibers 22 fill the polymer in an amount of thirty five percent (35%) by weight based on the combined total weight of the polymer and the fibers 22. The fibers 22 improve the impact resistance with or without the non-fiber impact modifiers referenced above. Preferably, the fibers 22 are glass fibers; however it should be appreciated that the fibers 22 may include or be some other material. It is to be understood that the fibers 22 may vary in size (e.g. length, diameter, etc.) and may be coated or uncoated. For example, in one embodiment, it is preferred that the fibers have an average diameter of less than 13 microns. In other embodiments, it is preferred that the fibers have an average diameter of 10 microns or less. The polymer or the fibers 22 themselves may include other components to encourage bonding between the polymer itself and the fibers 22.

The polymer should be resistant to fracturing upon impact with an object over a wide range of temperatures varying between the ranges of −40° C. and 150° C. Although not required, the polymer preferably has a modulus of elasticity (Young's Modulus) between the range of 3,500 MPa and 10,000 MPa. The polymer also preferably has a particular strength. The strength of the polymer may comprise a fatigue strength, a drop weight impact strength, and/or a notched impact strength. The fatigue strength is preferably between the range of 30 MPa and 60 MPa. The drop weight impact strength is preferably between the range of 75 kJ/m² and 110 kJ/m². The notched impact strength is preferably between the range of 12 kJ/m² and 22 kJ/m². Examples of suitable polymers include, but are not limited to Ultramid® polyamides commercially available from BASF Corp. Preferably, the polymer includes Ultramid® B3ZG7 OSI, PA6, 35% glass filled by weight, which is commercially available from BASF Corp.

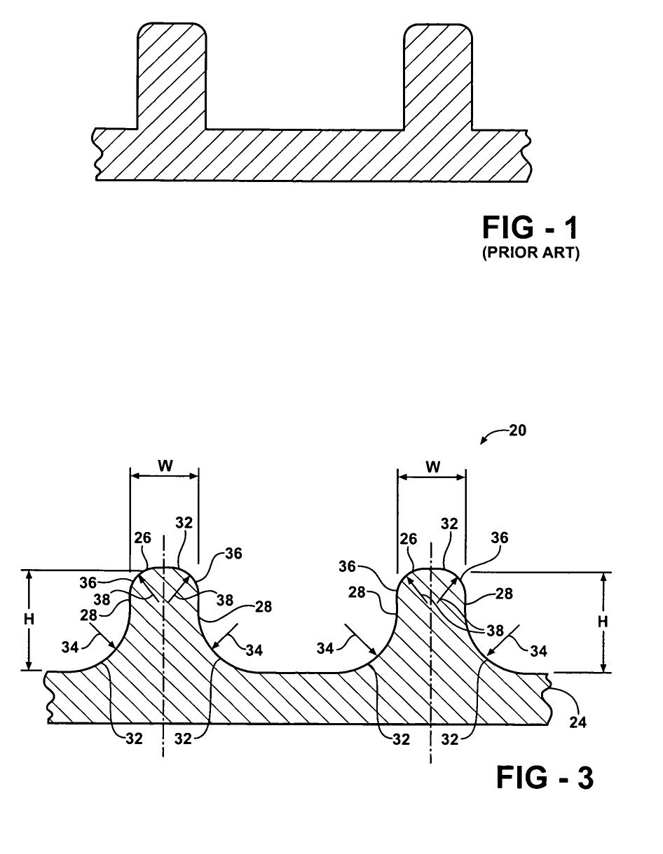

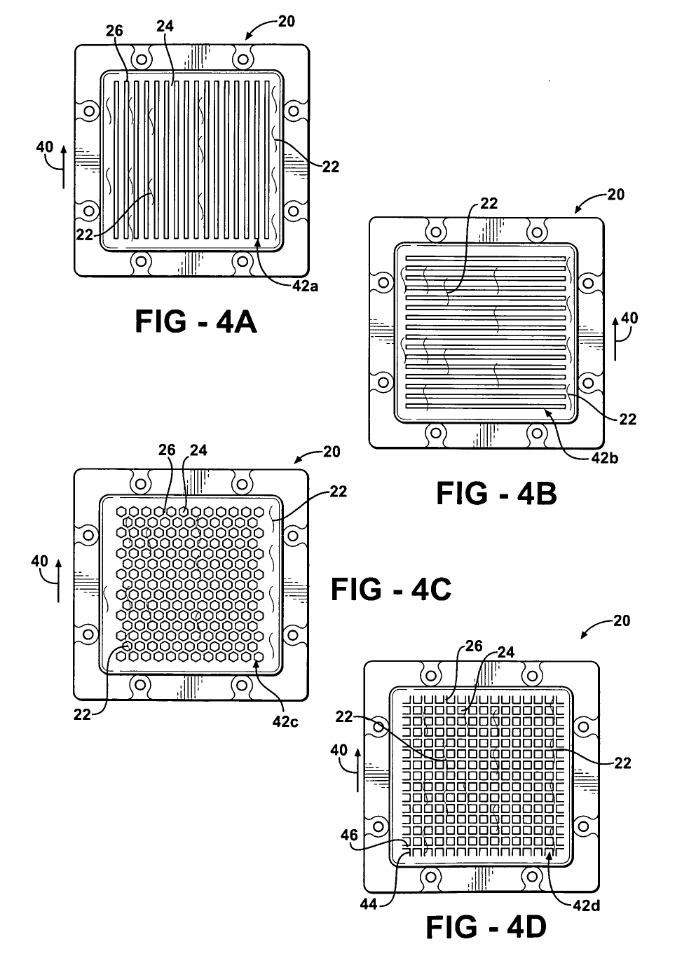

As shown in FIG. 2, the article 20 is formed as a fluid reservoir, and more specifically, the article 20 is formed as an oil pan for an internal combustion engine. As shown in FIGS. 4A-4E, the article 20 is formed as a cover. It should be understood that the article 20 may be formed into something other than the fluid reservoir or the cover and still fall within the scope of the disclosure, such as a gas tank, a engine coolant overflow tank, power steering fluid reservoir, etc. Additionally, it should be understood that the article 20 may be for vehicles other than an automobile, such as a boat, a plane, a tractor, etc.

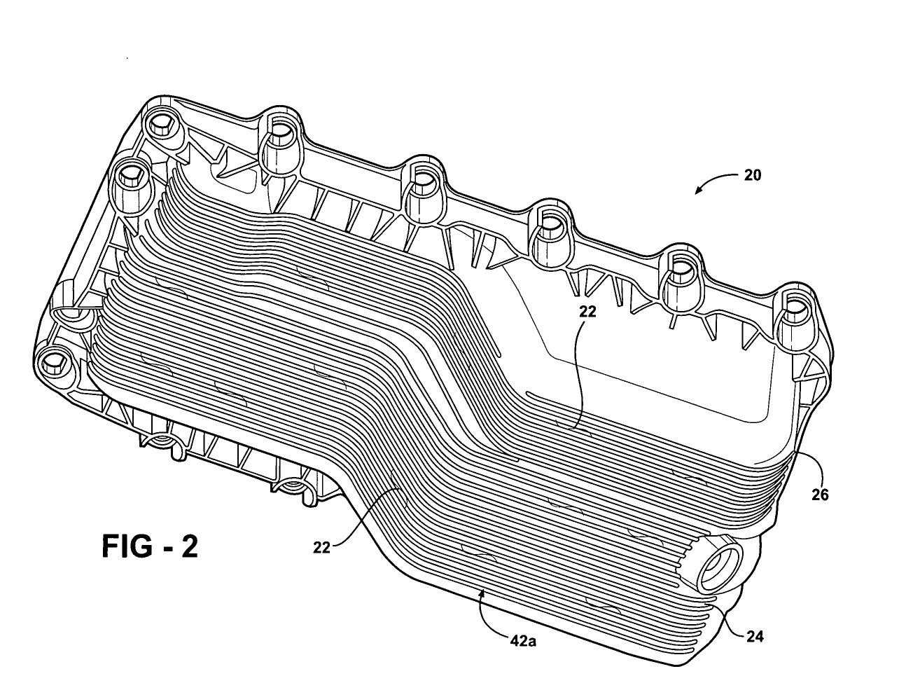

Referring to FIG. 3 the article 20 includes a planar portion 24, with a plurality of ribs 26 extending from the planar portion 24. Each of the ribs 26 includes a pair of side surfaces 28 in spaced parallel relationship and perpendicular to the planar portion 24. Each of the ribs 26 also includes a top surface 30 spaced from the planar portion 24 and extending between the pair of side surfaces 28. A fillet 32 interconnects each of the side surfaces 28 of the ribs 26 and the planar portion 24 of the article 20. Preferably, the fillet 32 includes a fillet radius 34 between the range of 0.75 mm and 2.00 mm. More preferably, the fillet radius 34 is equal to 1.5 mm. However, it should be appreciated that the fillet radius 34 may vary from the preferred range and still fall within the scope of the invention. As described above, the article 20 includes, among other possible portions and/or components, a planar portion 24, a plurality of ribs 26, and a fillet 32, and at least one, if not all, of the planar portion 24, the plurality of ribs 26, and the fillet 32 are formed from the polymer. As the article 20 is manufactured from the polymer as described above, it is preferred that the planar portion 24, the ribs 26, and the fillet 32 are all integrally formed together during the molding process from the polymer.

A corner 36 interconnects each of the side surfaces 28 of the ribs 26 and the top surface 30 of the ribs 26. Preferably, each of the corners 36 includes a corner radius 38 between the range of 0.50 mm and 1.00 mm. More preferably, the corner radius 38 is equal to 0.75 mm. However, it should be understood that the corner radius 38 may vary from the preferred range and still fall within the scope of the invention.

The top surface 30 of the ribs 26 is spaced from the planar portion 24 to define a height H. The height H is preferably between the range of 2.00 mm and 6.00 mm. More preferably, the height H is equal to 3.00 mm. However, it should be appreciated that the height H may vary from the preferred range and still fall within the scope of the invention.

The side surfaces 28 of the ribs 26 are spaced apart from each other to define a width W. The width W is preferably between the range of 2.00 mm and 3.00 mm. More preferably, the width W is equal to 2.20 mm. However, it should be appreciated that the width W may vary from the preferred range and still fall with in the scope of the invention.

Depending upon the specific use of the article 20, the article 20 may have to meet specific impact resistance design requirements. In other words, the article 20 may need to include an impact resistance capable of resisting a predetermined impact force. For example, when the fluid reservoir shown in FIG. 2 is incorporated into a vehicle as the oil pan of an engine, the oil pan must be resistant to an impact force transmitted to the oil pan from a flying object, such as a stone. The ribs 26 of the subject invention improve the impact resistance of the article 20 beyond the capabilities known in the prior art and depicted in FIG. 1. The fillet 32 interconnecting the side surfaces 28 of the ribs 26 and the planar portion 24 spreads the impact force over a larger area of the planar portion 24, thereby minimizing the concentrated stress previously encountered in the prior art between the side surfaces 28 of the ribs 26 and the planar portion 24 to improve the impact resistance of the article 20.

Additionally, as described above, the impact resistance is also dependent upon the orientation of the ribs 26 relative to the orientation of the aligned fibers 22 in the article 20. The fibers 22 substantially align themselves in a primary direction 40 parallel to a flow of the polymer when injected into a mold during a molding process. The direction of the polymer flow during the molding process, and therefore the direction of the aligned fibers 22 relative to the ribs 26, affects the impact resistance of the article 20. Accordingly, the plurality of ribs 26 includes a geometric orientation 42 relative to the primary direction 40 of the aligned fibers 22.

Referring to FIGS. 4A through 4E, different geometric orientations 42a, 42b, 42c, 42d, 42e of the ribs 26 relative to the primary direction 40 of the aligned fibers 22 are shown on the respective covers. In addition to the geometric configuration of the ribs 26 of the subject invention described above, the geometric orientation 42a, 42b, 42c, 42d, 42e of the ribs 26 on the planar portion 24 also improves the impact resistance of the polymer article 20. The effectiveness of the different geometric orientations 42a, 42b, 42c, 42d, 42e of the ribs 26 in increasing the impact resistance of the article 20 is dependent upon the orientation of the ribs 26 relative to the primary direction 40 of the aligned fibers 22 in the article 20. As described above, the strength of the polymer article 20 is greatest when a load is applied in a direction parallel to the primary direction 40 of the aligned fibers 22 and is weakest when the load is applied in a direction perpendicular to the primary direction 40 of the aligned fibers 22. However, the resistance to elongation of the polymer article 20 is greatest when the load is applied in a direction perpendicular to the primary direction 40 of the aligned fibers 22 and is least when the load is applied in a direction parallel to the primary direction 40 of the aligned fibers 22. The impact resistance of the article 20 is dependent upon both the strength and the resistance to elongation. Therefore, the overall increase in impact resistance provided by the ribs 26 is also dependent upon the strength and the resistance to elongation and the interrelationship between the geometric orientations 42a, 42b, 42c, 42d, 42e of the ribs 26 with respect to the primary direction 40 of the aligned fibers 22 in the article 20.

FIG. 4A shows a first geometric orientation 42a of the ribs 26 oriented uniaxially parallel to the direction of the polymer flow during the molding process, i.e., the ribs 26 are aligned parallel to the primary direction 40 of the aligned fibers 22 in the article 20. Referring also to FIG. 2, the geometric orientation 42a of the ribs 26 on the fluid reservoir incorporates the uniaxial orientation parallel to the primary direction 40 of the aligned fibers 22. FIG. 4B shows a second geometric orientation 42b of the ribs 26 oriented uniaxially perpendicular to the primary direction 40 of the aligned fibers 22. FIG. 4C shows a third geometric orientation 42c of the ribs 26 arranged in a hexagonal (honeycomb) pattern.

The plurality of ribs 26 may include a first portion 44 of the plurality of ribs 26 and a second portion 46 of the plurality of ribs 26. The first portion 44 of the plurality of ribs 26 is arranged perpendicular to the second portion 46 of the plurality of ribs 26. FIG. 4D shows a fourth geometric orientation 42d of the ribs 26 oriented in a square grid pattern with the first portion 44 of the plurality of ribs 26 arranged parallel to the primary direction 40 of the aligned fibers 22 and the second portion 46 of the plurality of ribs 26 arranged perpendicular to the primary direction 40 of the aligned fibers 22. FIG. 4E shows a fifth geometric orientation 42e of the ribs 26 oriented in a square grid pattern with the first portion 44 of the plurality of ribs 26 arranged at a forty five degree (45°) angle relative to the primary direction 40 of the aligned fibers 22 and the second portion 46 of the plurality of ribs 26 arranged at a forty five degree (45°) angle relative to the primary direction 40 of the aligned fibers 22 and perpendicular to the first portion 44 of the plurality of ribs 26.

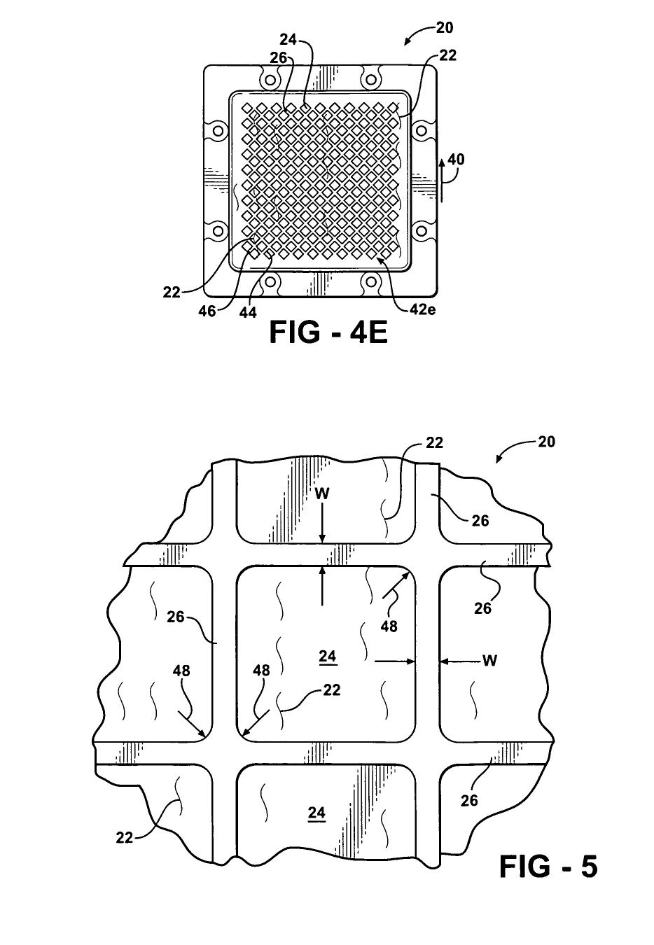

Referring to FIG. 5, a top view of the fourth and fifth geometric orientations 42d, 42e shown in FIGS. 4D and 4E shows an intersection between the first portion 44 of the plurality of ribs 26 and the second portion 46 of the plurality of ribs 26. The intersection between the first portion 44 of the plurality of ribs 26 and the second portion 46 of the plurality of ribs 26 includes a top radius 48 preferably between the range of 0.50 mm and 1.50 mm. More preferably, the top radius 48 is equal to 0.75 mm. However, it should be appreciated that the top radius 48 may vary from the preferred range and still fall within the scope of the invention.

A comparison test was conducted between the polymer cover shown in FIG. 4D manufactured in accordance with the subject invention and a standard prior art oil pan manufactured from cast aluminum. The polymer cover of the subject invention includes the geometric orientation 42d of the ribs 26. As described above, the geometric orientation 42d included the ribs 26 arranged in a square grid pattern with the first portion 44 of the ribs 26 arranged parallel to the primary direction 40 of the aligned fibers 22 and the second portion 46 of the ribs 26 arranged perpendicular to the primary direction 40 of the aligned fibers 22 and perpendicular to the first portion 44 of the ribs 26. The polymer cover of the subject invention includes the ribs 26 having a geometric configuration. The geometric configuration included a thickness of the planar portion 24 equal to 3.00 mm, a rib 26 height H equal to 3.00 mm, a fillet radius 34 equal to 1.50 mm, a rib 26 width W equal to 2.20 mm, a corner radius 38 equal to 0.75 mm and a rib 26 separation distance between parallel rows of ribs 26 of the square grid geometric orientation 42d equal to 7.80 mm. The polymer cover of the subject invention was manufactured from Ultramid® B3ZG7 OSI, PA6, 35% by weight glass filled, available from BASF Corp. The comparison test was conducted at twenty three degrees Celsius (23° C.). A twenty five millimeter (25.0 mm) diameter impactor having a hemi-spherical tip and a mass of one hundred three grams (103g) was individually accelerated at the center of the polymer cover and the cast aluminum oil pan by a pneumatic cylinder. The speed of the impactor was measured by a velocity sensor. The test showed that the polymer cover included an initial cracking speed between the range of 60 mph and 65 mph, whereas the cast aluminum oil pan included an initial cracking speed of approximately 50 mph. Additionally, the polymer cover displayed a measured oil leakage rate at the initial cracking speed of 0.17 cc/min., whereas the cast aluminum oil pan displayed a measured oil leakage rate at the initial cracking speed of 0.70 cc/min.

The invention has been described in an illustrative manner, and it is to be understood that the terminology which has been used is intended to be in the nature of words of description rather than of limitation. As is now apparent to those skilled in the art, many modifications and variations of the present invention are possible in light of the above teachings. It is, therefore, to be understood that within the scope of the appended claims, wherein reference numerals are merely for convenience and are not to be in any way limiting, the invention may be practiced otherwise than as specifically described.

What is claimed is:

1. An impact resistant article comprising:
a planar portion;
a plurality of ribs extending outwardly from said planar portion;
said plurality of ribs including a pair of side surfaces in spaced parallel relationship and perpendicular to said planar portion and a top surface extending between said pair of side surfaces;
said pair of side surfaces spaced from each other a width between the range of 2.00 mm and 3.00 mm;
said top surface being parallel to and spaced from said planar portion a height between the range of 2.00 mm and 6.00 mm; and
a fillet interconnecting said planar portion and each of said pair of side surfaces and having a fillet radius between the range of 0.75 mm and 2.00 mm.

2. An article as set forth in claim 1 further comprising a corner interconnecting said top surface and each of said pair of side surfaces and having a corner radius between the range of 0.50 mm and 1.00 mm.

3. An article as set forth in claim 2 wherein said corner radius is equal to 0.75 mm.

4. An article as set forth in claim 1 wherein said height between said top surface and said planar portion is equal to 3.00 mm.

5. An article as set forth in claim 1 wherein said width between said pair of side surfaces is equal to 2.20 mm.

6. An article as set forth in claim 1 wherein said fillet radius is equal to 0.75 mm.

7. An article as set forth in claim 1 wherein at least one of said planar portion, said plurality of ribs, and said fillet are formed from a polymer.

8. An article as set forth in claim 7 wherein said planar portion, said plurality of ribs, and said fillet are integrally formed together from said polymer.

9. An article as set forth in claim 8 wherein said polymer includes nylon.

10. An article as set forth in claim 9 wherein said nylon includes one of a nylon 6 and a nylon 6/6.

11. An article as set forth in claim 7 further comprising fibers filling said polymer in an amount of from 30% to 40% by weight based on a combined total weight of said polymer and said fibers.

12. An article as set forth in claim 11 wherein said fibers are glass fibers.

13. An article as set forth in claim 11 wherein said fibers fill said polymer in an amount of 35% by weight based on the combined total weight of said polymer and said fibers.

14. An article as set forth in claim 7 wherein said polymer has a modulus of elasticity between the range of 3,500 MPa and 10,000 MPa.

15. An article as set forth in claim 7 wherein said polymer has a fatigue strength between the range of 30 MPa and 60 MPa.

16. An article as set forth in claim 7 wherein said polymer has a drop weight impact strength between the range of 75 KJ/m² and 110 KJ/m².

17. An article as set forth in claim 7 wherein said polymer has a notched impact strength between the range of 12 KJ/m² and 22 KJ/m².

18. An article as set forth in claim 10 wherein said fibers have an average diameter of less than 13 microns.

19. An article as set forth in claim 10 wherein said fibers have an average diameter of 10 microns or less.

20. An impact resistant article comprising:
a planar portion;
a plurality of ribs extending outwardly from said planar portion;
said plurality of ribs including a pair of side surfaces in spaced parallel relationship and perpendicular to said planar portion and a top surface extending between said pair of side surfaces; and
a fillet interconnecting said planar portion and each of said pair of side surfaces and having a fillet radius between the range of 0.75 mm and 2.00 mm;
said planar portion, said plurality of ribs and said fillet being integrally formed from a polymer filled with fibers in an amount of from 30% to 40% by weight based on a combined total weight of said polymer and said fibers;
said fibers being substantially oriented in a primary direction with said plurality of ribs including a geometric orientation relative to said primary direction.

21. An article as set forth in claim 18 wherein said geometric orientation of said plurality of ribs includes said plurality of ribs extending parallel to said primary direction.

22. An article as set forth in claim 18 wherein said geometric orientation of said plurality of ribs includes said plurality of ribs extending perpendicular to said primary direction.

23. An article as set forth in claim 18 wherein said geometric orientation of said plurality of ribs includes said plurality of ribs arranged to define a plurality of hexagonal shapes.

24. An article as set forth in claim 18 wherein said plurality of ribs includes a first portion of said plurality of ribs and a second portion of said plurality of ribs and wherein geometric orientation of said plurality of ribs includes said first portion of said plurality of ribs arranged perpendicularly to said second portion of said plurality of ribs.

25. An article as set forth in claim 22 further comprising an intersection between said first portion of said plurality of ribs and said second portion of said plurality of ribs with said intersection including a top radius between the range of 0.50 mm and 1.50 mm.

26. An article as set forth in claim 23 wherein said top radius is equal to 0.75 mm.

27. An article as set forth in claim 23 wherein said geometric orientation of said plurality of ribs includes said first portion of said plurality of ribs arranged parallel said primary direction and said second portion of said plurality of ribs arranged perpendicular to said primary direction.

28. An article as set forth in claim 23 wherein said geometric orientation of said plurality of ribs includes said first portion of said plurality of ribs arranged at a 45° angle relative to said primary direction and said second portion of said plurality of ribs arranged at a 45° angle relative to said primary direction and perpendicular to said first portion of said plurality of ribs.

29. An article as set forth in claim 18 wherein said top surface is parallel to and spaced from said planar portion a height between the range of 2.00 mm and 6.00 mm.

30. An article as set forth in claim 18 wherein said pair of side surfaces is spaced from each other a width between the range of 2.00 mm and 3.00 mm.

31. An article as set forth in claim 18 further comprising a corner interconnecting said top surface and each of said pair of side surfaces and having a corner radius between the range of 0.50 mm and 1.00 mm.

32. An article as set forth in claim 19 wherein said fibers have an average diameter of less than 13 microns.
